(19) United States
(12) Patent Application Publication
(10) Pub. No.: US 2014/0289370 A1
(43) Pub. Date: Sep. 25, 2014

(54) LOG MANAGEMENT SYSTEM, LOG MANAGEMENT METHOD, IMAGE FORMING APPARATUS AND CONTROL METHOD THEREOF, AND NON-TRANSITORY COMPUTER-READABLE MEDIUM

(71) Applicant: CANON KABUSHIKI KAISHA, Tokyo (JP)

(72) Inventor: Yoshinobu Hamada, Yokohama-shi (JP)

(73) Assignee: CANON KABUSHIKI KAISHA, Tokyo (JP)

(21) Appl. No.: 14/184,527

(22) Filed: Feb. 19, 2014

(30) Foreign Application Priority Data
Mar. 19, 2013 (JP) 2013-057305

(51) Int. Cl. H04L 29/08

(52) U.S. Cl. CPC H04L 67/1002
USPC 709/219

(57) ABSTRACT

A log management system in which log information sent from an image forming apparatus via a load balancer, which distributes a storage destination of log information, is managed by a plurality of storage servers, the system comprises: a management unit which manages identification information of a first storage server, which received first log information including image data, of the plurality of storage servers in association with identification information of the image data; and a control unit which controls a second storage server, which received second log information which does not include the image data and includes the identification information of the image data as reference information of the image data to copy and store the image data from the first storage server specified by using information managed by the management unit and the reference information included in the second log information.

### BACKGROUND OF THE INVENTION

1. Field of the Invention

The present invention relates to a log management system, log management method, image forming apparatus and control method thereof, and non-transitory computer-readable medium and, more particularly, to a system which records and audits users who executed jobs, printed images, and the like as history information in association with print jobs, copy jobs, and the like executed by an image forming apparatus.

2. Description of the Related Art

Conventionally, a system, which manages history information related to jobs executed by a printer and MFP (Multi Function Peripheral) so as to suppress information leakage and to trace leakers, has been developed. Some such systems store image data processed by jobs such as printed images in addition to information of job execution users, execution dates and times, and the like. It is concerned for this system that a huge storage capacity is required so as to store image data for an extended period of time.

For example, in a certain image forming apparatus, a job for an image which is the same as that of an already recorded job history records, in a job history, reference information to image data of that already recorded job history in place of image data (for example, see Japanese Patent Laid-Open No. 2011-223594). Thus, a storage capacity required to store job histories is reduced.

In a large-scale environment in which a log management system has to manage a large number of image forming apparatuses and huge quantities of job histories, a plurality of servers which store job histories are often prepared so as to assure high search performance upon storage and use of job histories. Furthermore, in order to distribute loads using a plurality of servers, a load balancer is arranged between the image forming apparatuses and the plurality of servers. When such environment adopts the method described in Japanese Patent Laid-Open No. 2011-223594, a job history which includes image data to be referred to and that including only reference information are unwantedly stored in different servers, and image data to be referred to often cannot be found. At the time of use, it is possible to find image data to be referred to by searching respective serves in association with a job history including only reference information. However, the search performance at the time of use is considerably impaired.

### SUMMARY OF THE INVENTION

The present invention has been made to solve the aforementioned problems, and reduces a capacity of job histories to be recorded in an image forming apparatus and suppresses a search performance drop at the time of use in a large-scale environment.

According to one aspect of the present invention, there is provided a log management system in which log information sent from an image forming apparatus via a load balancer, which distributes a storage destination of log information, is managed by a plurality of storage servers, the system comprising: a management unit configured to manage identification information of a first storage server, which received first log information including image data, of the plurality of storage servers in association with identification information of the image data; and a control unit configured to control a second storage server, which received second log information which does not include the image data and includes the identification information of the image data as reference information of the image data to copy and store the image data from the first storage server specified by using information managed by the management unit and the reference information included in the second log information.

According to another aspect of the present invention, there is provided a log management system in which log information sent from an image forming apparatus via a load balancer, which distributes a storage destination of the log information, is managed by a plurality of storage servers, the system comprising: a management unit configured to manage identification information of a first storage server, which received first log information including image data, of the plurality of storage servers in association with identification information of the image data; and a control unit configured to control a second storage server which received second log information which does not include the image data and includes the identification information of the image data as reference information of the image data to transfer the second log information to the specified storage server specified by using information by the management unit and the reference information included in the second log information.

According to another aspect of the present invention, there is provided a log management system in which log information sent from an image forming apparatus via a load balancer, which distributes a storage destination of the log information, is managed by a plurality of storage servers, the system comprising: a search unit configured to search for a first storage server, which stores image data, of the plurality of storage servers; and a control unit configured to control a second storage server which received log information which does not include the image data and includes the identification information of the image data as reference information of the image data to copy and store the image data from the first storage server found on the basis of the reference information included in the log information by the search unit.

According to another aspect of the present invention, there is provided an image forming apparatus connected to a log management system including a plurality of storage servers to which a storage destination of log information is distributed by a load balancer, the apparatus comprising: a sending unit configured to send log information of job processing to the log management system; a receiving unit configured to receive identification information of the storage server serving as a storage destination of the log information as a response to the log information sent by the sending unit; and a holding unit configured to hold identification information of image data corresponding to the log information and the identification information of the storage server received by the receiving unit in a storage unit in association with each other, wherein when the sending unit sends log information, the sending unit determines based on information held in the holding unit which of the plurality of storage servers stores image data corresponding to the log information, and if the image data is stored in any of the plurality of storage servers, the sending unit sends log information which does not include the image data and includes identification information of the image data as reference information of the image data.

According to another aspect of the present invention, there is provided a control method in a log management system in which log information sent from an image forming apparatus via a load balancer, which distributes a storage destination of the log information, is managed by a plurality of storage servers, the method comprising: a management step of managing identification information of a first storage server, which received first log information including image data, of the plurality of storage servers in association with identification information of the image data; and a control step of controlling a second storage server which received second log information which does not include the image data and includes the identification information of the image data as reference information of the image data to copy and store the image data from the first storage server specified by using information managed in the management step and the reference information included in the second log information.

According to another aspect of the present invention, there is provided a control method of an image forming apparatus connected to a log management system including a plurality of storage servers to which a storage destination of log information is distributed by a load balancer, the method comprising: a sending step of sending log information of job processing to the log management system; a receiving step of receiving identification information of the storage server serving as a storage destination of the log information as a response to the log information sent in the sending step; and a holding step of holding identification information of image data corresponding to the log information and the identification information of the storage server received in the receiving step in a storage unit in association with each other, wherein in the sending step, when log information is sent, it is determined based on information held in the storage unit which of the plurality of storage servers stores image data corresponding to the log information, and if the image data is stored in any of the plurality of storage servers, log information, which does not include the image data and includes identification information of the image data as reference information of the image data, is sent.

According to another aspect of the present invention, there is provided a non-transitory computer-readable medium storing a program for controlling a computer to function as: a sending unit configured to send log information of job processing to a log management system including a plurality of storage servers to which a storage destination of log information is distributed by a load balancer; a receiving unit configured to receive identification information of the storage server serving as a storage destination of the log information as a response to the log information sent by the sending unit; and a holding unit configured to hold identification information of image data corresponding to the log information and the identification information of the storage server received by the receiving unit in a storage unit in association with each other, wherein when the sending unit sends log information, the sending unit determines based on information held in the holding unit which of the plurality of storage servers stores image data corresponding to the log information, and if the image data is stored in any of the plurality of storage servers, the sending unit sends log information which does not include the image data and includes identification information of the image data as reference information of the image data.

In a large-scale environment, a capacity of job histories to be recorded in an image forming apparatus is reduced, and a search performance drop at the time of use is suppressed.

Further features of the present invention will become apparent from the following description of exemplary embodiments (with reference to the attached drawings).

### BRIEF DESCRIPTION OF THE DRAWINGS

FIG. 1 is a view showing an example of the configuration of a log management system according to the present invention;

FIG. 2 is a block diagram showing an example of the hardware arrangement of an MFP;

FIG. 3 is a block diagram showing an example of the hardware arrangement of a job history storage server and management server;

FIG. 4 is a block diagram showing an example of the software configuration of the MFP;

FIG. 5 is a block diagram showing an example of the software configuration of the job history storage server;

FIG. 6 is a block diagram showing an example of the software configuration of the management server;

FIG. 7 is a table showing the contents of jobs to be executed by the MFP;

FIG. 8 is a table showing an example of a job history to be recorded by the MFP;

FIG. 9A is a flowchart showing the processing sequence executed when the MFP sends a job history;

FIG. 9B is a flowchart showing the processing sequence executed when the job history storage server receives a job history;

FIG. 10 is a view showing an example of a search screen displayed by the management server;

FIG. 11A is a flowchart showing the processing sequence executed when an MFP sends a job history according to the second embodiment;

FIG. 11B is a flowchart showing the processing sequence executed when a job history storage server issues a content copy request according to the second embodiment;

FIG. 12A is a flowchart showing the processing sequence after job execution of an MFP according to the third embodiment;

FIG. 12B is a flowchart showing the processing sequence after operation execution of the MFP according to the third embodiment;

FIG. 12C is a flowchart showing the processing sequence executed when a job history sent by the MFP is to be deleted according to the third embodiment;

FIG. 13 is a block diagram showing an example of the software configuration of a job history storage server according to the fourth embodiment;

FIG. 14 is a flowchart showing the processing sequence executed when the job history storage server receives a job history according to the fourth embodiment;

FIG. 15 is a block diagram showing an example of the software configuration of a job history storage server according to the fifth embodiment;

FIG. 16 is a flowchart showing the processing sequence executed when an MFP sends a job history according to the fifth embodiment;

FIG. 17 is a block diagram showing an example of the software configuration of a management server according to the sixth embodiment;

FIG. 18A is a flowchart showing the processing sequence executed when an MFP sends a job history according to the sixth embodiment;

FIG. 18B is a flowchart showing the processing sequence executed when a job history storage server receives a job history according to the sixth embodiment;

FIG. 19 is a block diagram showing an example of the software configuration of a management server according to the seventh embodiment;

FIG. 20A is a flowchart showing the processing sequence executed when a job history storage server receives a job history according to the seventh embodiment; and

FIG. 20B is a flowchart showing the processing sequence upon conducting a registration destination search of a management server according to the seventh embodiment.

### DESCRIPTION OF THE EMBODIMENTS

Embodiments of the present invention will be described hereinafter with reference to the drawings.

Terms to be used in the following description will be explained first. A job, which stores reusable image data in an MFP, will be referred to as “input job”. A job when image data stored by the input job is reused (for example, printed) will be referred to as “output job”.

A job history (log information) to be recorded by the MFP includes image data to be referred to (to be referred to as a log image hereinafter) or reference information to a stored log image in addition to attribute information to be described below. The attribute information includes job execution user information, jog execution date and time, information required to identify an MFP which executed a job (an IP address, MFP identification number, and the like), an executed job type (print, copy, and the like), and so forth. A log image is image data which is recorded to use an image handled by a job. Reference information to a stored log image is identification information (to be referred to as a document ID hereinafter) of a log image stored as a job history of an input job.

Of job histories, a job history including attribute information and a log image will be referred to as “normal log”, and a job history including attribute information and reference information to a stored log image will be referred to as “link log”. A combination of a log image or an image obtained by converting a log image and text obtained by applying OCR to a log image will be referred to as “content”, and the content is identified by a document ID. When a normal log is sent to a job history storage server as a storage server, it includes attribute information and a content.

### First Embodiment

The first embodiment of the present invention will be described below.

[System Configuration]

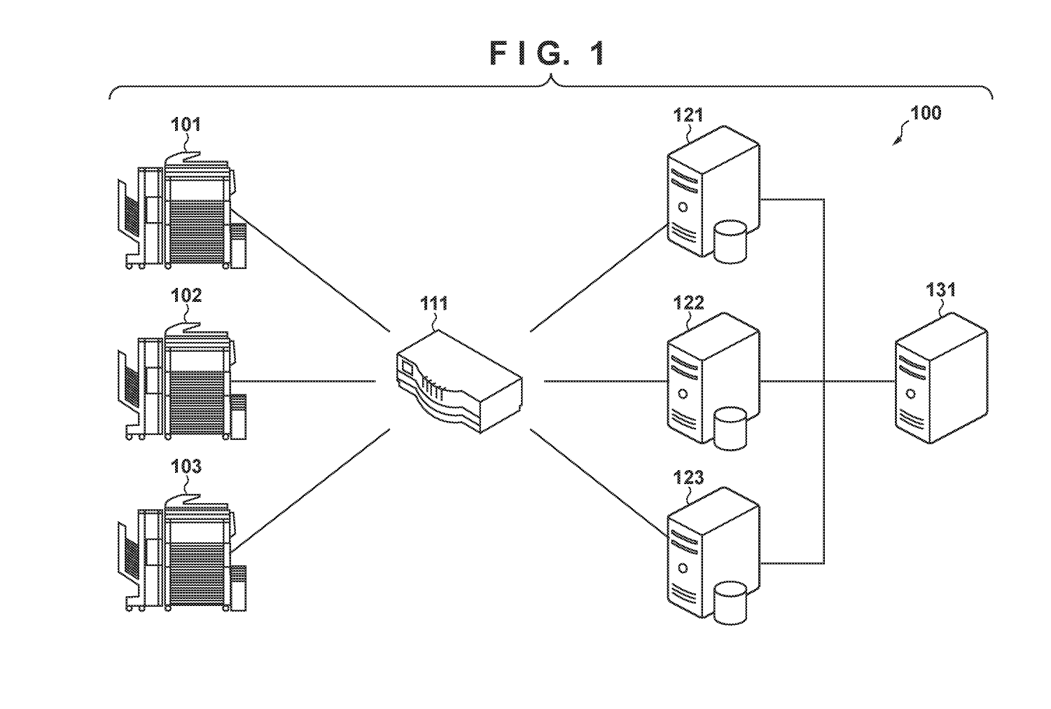

FIG. 1 is a view showing an example of the configuration of a log management system 100 according to the present invention. In a log management system 100 in this embodiment, MFPs 101 to 103 and job history storage servers 121 to 123 are connected via a load balancer 111. Furthermore, the job history storage servers 121 to 123 and a management server 131 are connected on a single network. Note that the numbers of servers and MFPs are not limited to those shown in FIG. 1, and one server and one MFP or larger numbers of servers and MFPs may be connected.

The job history storage servers 121 to 123 store job histories as execution records of jobs (copy jobs, print jobs, and the like) executed by the MFPs 101 to 103. The management server 131 manages settings and statuses of the overall log management system 100. Also, the management server 131 accepts a request from a user who uses a job history, searches for job histories stored in the job history storage servers 121 to 123, and presents merged search results to the user.

(Hardware Arrangement)

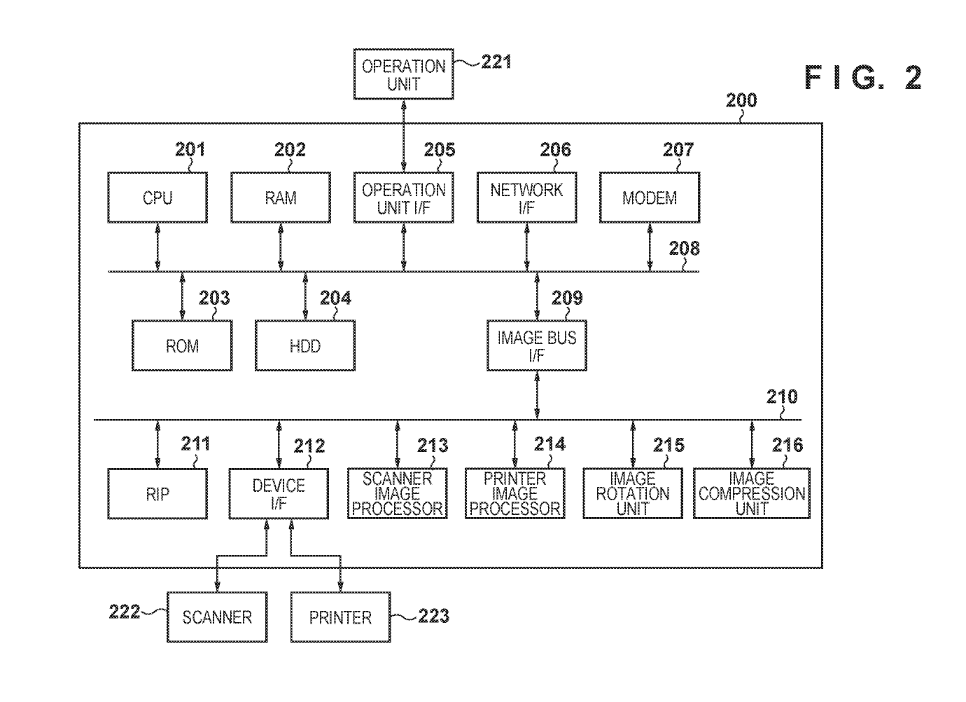

FIG. 2 is a block diagram showing an example of the hardware arrangement of the MFP 101. Note that the MFPs 102 and 103 also have the same hardware arrangement, and a description thereof will not be given. A controller unit 200 connects a scanner 222, printer 223, network, and public line so as to input/output image data and device information.

A CPU 201 controls the overall MFP 101. A RAM 202 is used as a work memory required for the operation of the CPU 201, and also as an image memory required to temporarily store input image data. A ROM 203 is a boot ROM, and stores a boot program of the system. An HDD 204 is a hard disk drive which stores system software, job histories, image data in a user box, and the like. An operation unit I/F 205 is an interface unit with an operation unit 221, and outputs screen data to be displayed on the operation unit 221 to the operation unit 221.

A network I/F 206 connects a network such as a LAN (Local Area Network) to input/output information. A modem 207 connects a public line to input/output image data. The aforementioned devices are arranged on a system bus 208. An image bus I/F 209 is a bus bridge which connects the system bus 208 and an image bus 210 used to transfer image data at high speed, and converts data structures. On the image bus 210, the following devices are arranged.

An RIP (Raster Image Processor) 211 expands PDL (Page Description Language) code data into a bitmap image. A device I/F 212 connects the scanner 222 and printer 223 as image input/output devices, and the controller unit 200 to convert image data. A scanner image processor 213 performs correction, modification, editing, and the like of input image data. A printer image processor 214 performs correction, resolution conversion, and the like according to the printer 223 for output image data. An image rotation unit 215 rotates image data. An image compression unit 216 performs compression/decompression processing of image data.

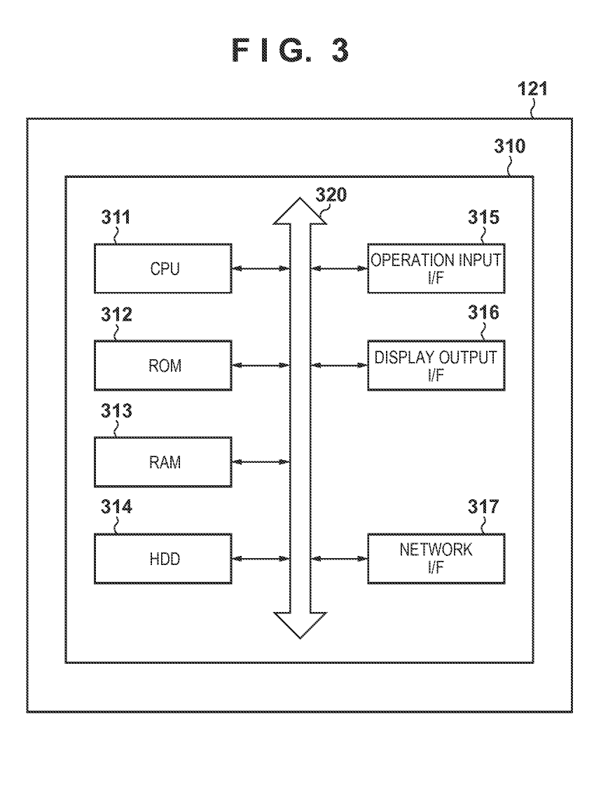

FIG. 3 is a block diagram showing an example of the hardware arrangement of the job history storage server 121. Note that the job history storage servers 122 and 123 and the management server 131 also have the same hardware arrangement, and a description thereof will not be given.

A control unit 310 including a CPU 311 controls the operation of the overall server. The CPU 311 reads out control programs stored in a ROM 312 and HDD 314, and executes various kinds of control processing such as input/output processing, and arithmetic processing. A RAM 313 is used as a main memory of the CPU 311 and a temporary storage area such as a work area. The HDD 314 stores job histories and various programs.

An operation input I/F 315 accepts signal inputs from connected operation devices such as a keyboard and mouse. A display output I/F 316 outputs a signal to a display (not shown) or the like, which is used to display a screen. A network I/F 317 connects the control unit 310 to a network, and exchanges information with other apparatuses on the network. A bus 320 connects the respective blocks in the control unit 310 to serve as a data communication path.

(Software Configuration)

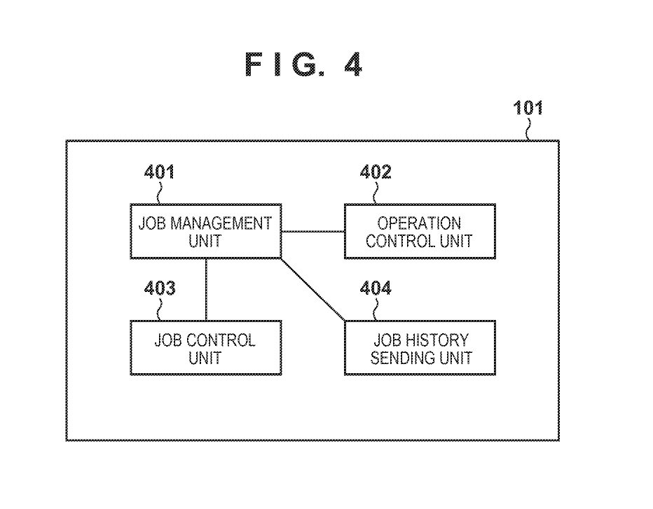

FIG. 4 is a block diagram showing an example of the software configuration of the MFP 101. Note that the MFPs 102 and 103 also have the same software configuration, and a description thereof will not be given.

A job management unit 401 performs execution of jobs accepted by an operation control unit 402 and those accepted via a network, recording of job histories in the HDD 204, job status management, and so forth. Also, the job management unit 401 issues an instruction to a job control unit 403 according to job processing contents. The operation control unit 402 controls to display an operation screen on a display panel included in the operation unit 221, accepts input information of an operation made on the operation unit 221, and transfers information to other functional units as needed. Note that the operation control unit 402 also controls remote operations via a network.

The job control unit 403 controls the scanner 222 and printer 223 to operate according to an instruction from the job management unit 401. Also, the job control unit 403 notifies the job management unit 401 of statuses of the scanner 222 and printer 223. A job history sending unit 404 sends a job history recorded in the HDD 204 to any of the job history storage servers 121 to 123 via the load balancer 111 to request that server to register the job history (job history registration request). If registration of the job history has succeeded, the job history sending unit 404 deletes that job history from the HDD 204. Also, the job history sending unit 404 receives identification information (SID) required to identify the job history storage server as the job history registration destination from that job history storage server as a response to the registration request. Then, when the sent job history is a normal log, the job history sending unit 404 records the received SID and a document ID included in the sent job history in a registration destination management table (not shown) in the HDD 204 in association with each other. Note that the registration destination management table may associate and hold required information in addition to the document ID and SID.

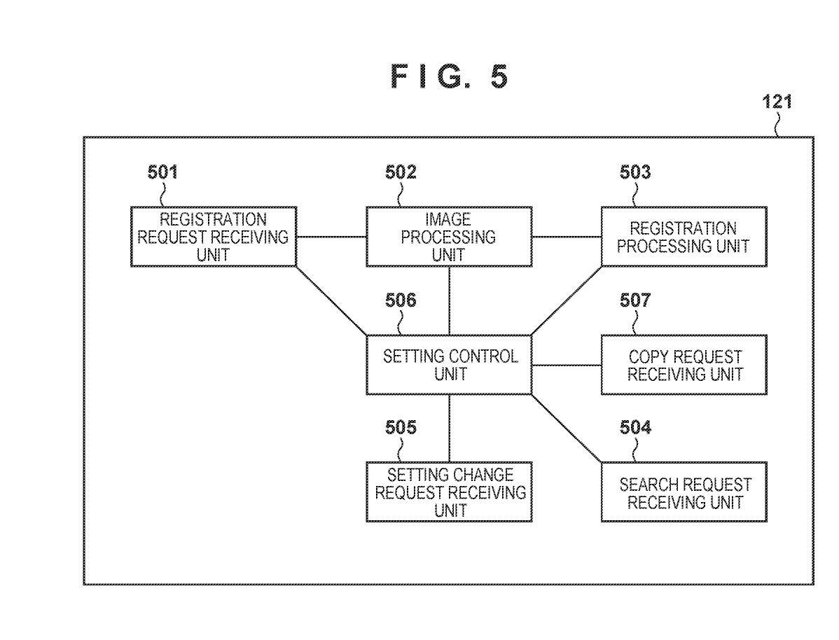

FIG. 5 is a block diagram showing an example of the software configuration of the job history storage server 121. Note that the job history storage servers 122 and 123 also have the same software configuration, and a description thereof will not be given.

A registration request receiving unit 501 accepts a job history registration request sent from the job history sending unit 404 of the MFP 101, and passes the accepted job history to an image processing unit 502. The image processing unit 502 performs text extraction by means of OCR processing, and conversions of an image format and resolution for a log image included in the job history passed from the registration request receiving unit 501. A registration processing unit 503 registers attribute information included in the job history, and the text and log image which are respectively extracted and converted by the image processing unit 502 in a database. However, if the job history to be registered is a link log, the registration processing unit 503 issues a content copy request to the job history storage server, which stores a link destination content, and registers a copy of that content in the database of itself together with attribute information included in the job history. At this time, assume that the registration processing unit 503 can specify another job history storage server based on an SID, and can issue a request. A search request receiving unit 504 accepts a job history search request from the management server 131, searches for a job history registered in the database by the registration processing unit 503, and returns a search result to the management server 131.

A setting change request receiving unit 505 accepts a setting change request related to the job history storage server 121 from the management server 131, and instructs a setting control unit 506 to change settings. The setting control unit 506 controls settings related to the job history storage server 121 and operation settings of the respective units, and processes reference instructions and setting change instructions from the respective units. Also, the setting control unit 506 also manages an SID required to identify each job history management server and its address information. A copy request receiving unit 507 accepts a content copy request from each job history storage server, and returns a corresponding content.

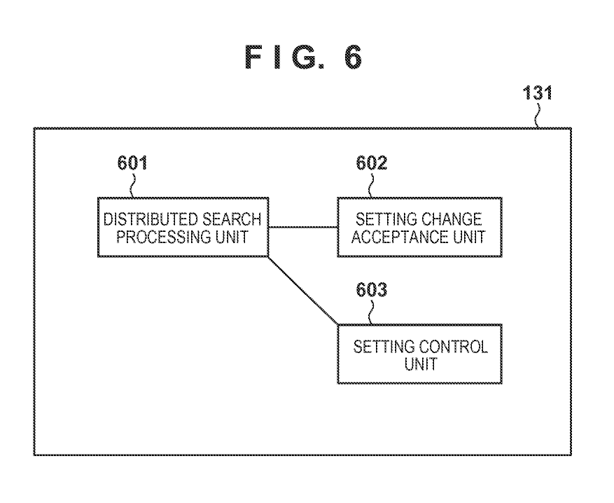

FIG. 6 is a block diagram showing an example of the software configuration of the management server 131. A distributed search processing unit 601 accepts a search instruction from the user, and issues a search request based on accepted conditions to the job history storage servers 121 to 123. Also, the distributed search processing unit 601 receives search results of the respective job history storage servers, merges these results, and presents the merged result to the user. A setting change acceptance unit 602 accepts and processes various setting changes of the log management system 100 from a system administrator. The setting change acceptance unit 602 issues a setting change instruction to the job history storage servers 121 to 123 as needed.

A setting control unit 603 controls settings of the management server 131 itself and those related to the overall log management system 100, and processes reference instructions and setting change instructions from the respective units. The setting control unit 603 also holds an SID of each job history storage server and its address information in association with each other.

[Processing Sequence]

(Description of Jobs)

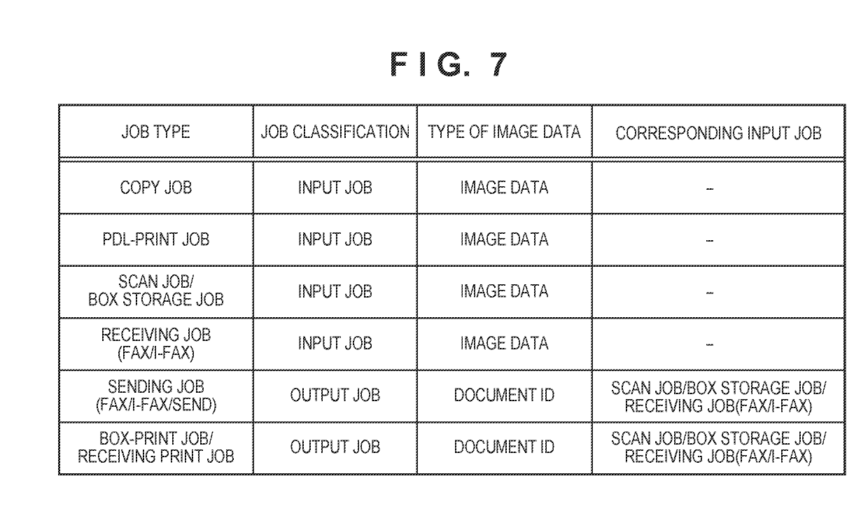

FIG. 7 is a table showing, in association with jobs to be executed by the MFP 101, classifications of an input job and output job, an image data recording method, and a corresponding input job in case of an output job. Referring to FIG. 7, a COPY job is an input job having a document read by the scanner 222 as an input image. When the input job is executed, the job management unit 401 records attribute information and a log image as a job history (that is, a normal log). At this time, the job management unit 401 appends a document ID required to uniquely identify the log image.

A BOX-PRINT job is an output job which performs a print operation using image data stored in advance in a user box area in the HDD 204 as a storage unit. When the output job is executed, the job management unit 401 records, in place of a log image, a document ID of a stored log image as reference information to that image as a job history (that is, a link log) together with attribute information. Note that an input job corresponding to the BOX-PRINT job, that is, a job, which has a possibility of recording the log image corresponding to the document ID recorded by the BOX-PRINT job, is a SCAN job/BOX storage job/receive job (FAX/I-FAX).

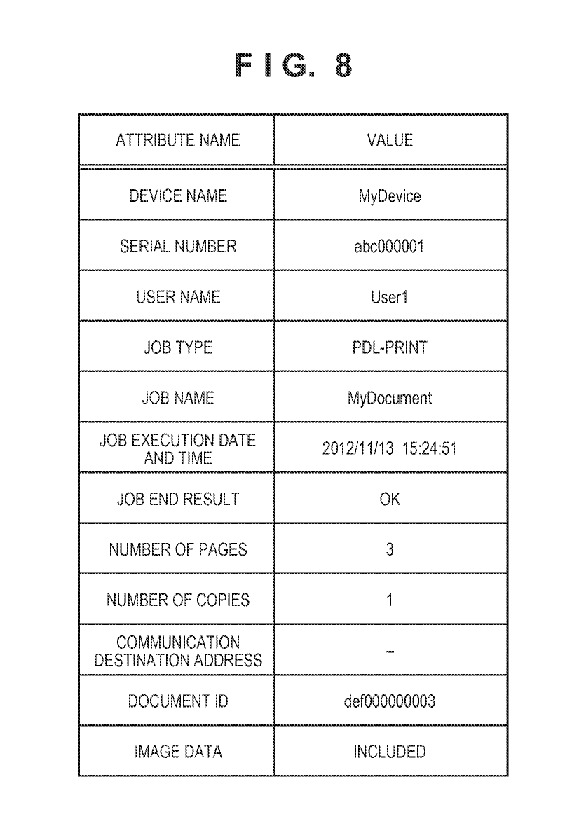

FIG. 8 is a table showing an example of attribute information of a job history generated by the job management unit 401 of the MFP 101. Note that a job history in which an “image data” attribute is “included” is a normal log, which includes image data in addition to this attribute information. A job history in which an “image data” attribute is “none” is a link log, which includes reference information in place of image data. In this case, a “document ID” attribute represents that reference information. In case of a normal log, the “document ID” attribute indicates a document ID of image data included in that log.

In addition, the attribute information includes information such as a device name, serial number of a device, user name, job type, job name, job execution date and time, job end result, the number of pages, the number of copies, and communication destination address. Note that the configuration of the attribute information is not limited to that shown in FIG. 8, and other kinds of information may be included. A job type included in the attribute information corresponds to that shown in FIG. 7.

(Job History Sending Processing)

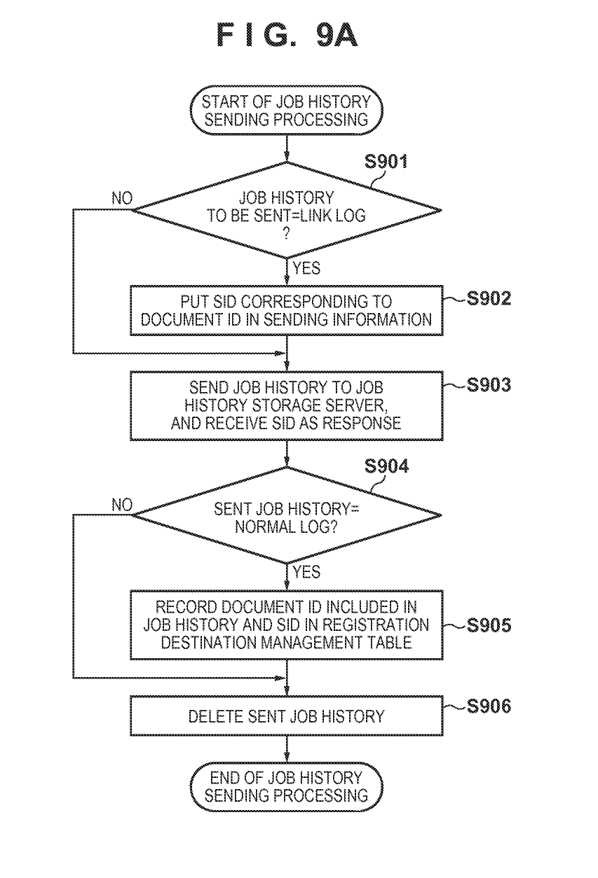

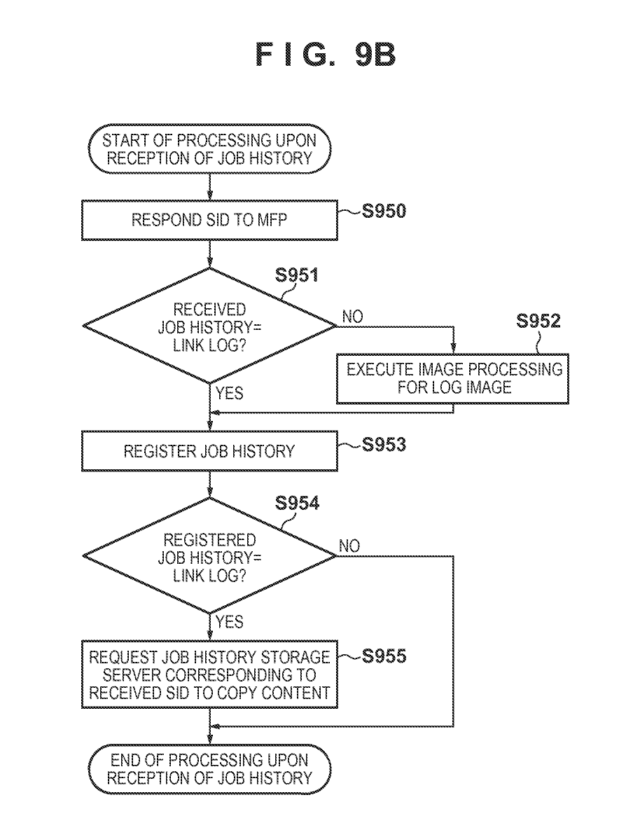

FIG. 9A is a flowchart showing the processing sequence executed when the job history sending unit 404 of the MFP 101 sends a job history recorded in the HDD 204. Respective steps shown in the flowchart of FIG. 9A are implemented when the CPU 201 of the MFP 101 executes a program which is stored in the ROM 203 or HDD 204 and is required to implement the job history sending unit 404. Also, the CPU 201 uses the RAM 202 and HDD 204 as storage areas as needed. Assume that the job history sending unit 404 refers to the HDD 204 at a pre-set time interval, and sends a job history when it finds the job history to be sent.

In step S901, the job history sending unit 404 selects oldest one of job histories to be sent as a job history of a sending target, and determines whether or not that job history is a link log. Whether or not the job history is a link log is determined by referring to a value of an “image data” attribute of attribute information of that job history. If this value is “none”, it is determined that the job history is a link log. Note that the present invention is not limited to this determination method. For example, the above determination may be made by directly confirming the presence/absence of image data. If the selected job history is a link log (YES in step S901), the job history sending unit 404 advances the process to step S902. If the selected job history is not a link log, that is, it is a normal log (NO in step S901), the job history sending unit 404 advances the process to step S903.

In step S902, the job history sending unit 404 acquires an SID corresponding to a document ID of the link log from the registration destination management table, and appends that SID to sending information of a job history registration request to the job history storage server. In step S903, the job history sending unit 404 sends the job history registration request to the registration request receiving unit 501 of any of the job history storage servers 121 to 123. The job history storage server in the system as a registration destination is decided by load distribution processing of the load balancer 111. Then, as a response to this sent request, the job history sending unit 404 receives response information including an SID of the job history storage server, which is sent from the registration request receiving unit 501 of the job history storage server that received the registration request.

The job history sending unit 404 determines in step S904 whether or not the sent job history is a normal log. Whether or not the sent job history is a normal log is determined by referring to a value of an “image data” attribute of attribute information of the job history. If this value is “included”, it is determined that the job history is a normal log. Note that the present invention is not limited to this determination method. For example, the above determination may be made by directly confirming the presence/absence of image data. If the sent job history is a normal log (YES in step S904), the job history sending unit 404 advances the process to step S905. If the sent job history is not a normal log, that is, it is a link log (NO in step S904), the job history sending unit 404 advances the process to step S906. In step S905, the job history sending unit 404 records a document ID of the normal log and the SID received in step S903 in the registration destination management table in association with each other. In step S906, the job history sending unit 404 deletes the sent job history from the HDD 204. Then, the job history sending unit 404 ends this processing sequence.

(Job History Receiving Processing)

FIG. 9B is a flowchart showing the processing sequence executed when the job history storage server 121 receives a job history from the job history sending unit 404 of the MFP 101. Respective steps shown in the flowchart of FIG. 9B are implemented when the CPU 311 of the job history storage server 121 executes programs which are stored in the ROM 312 or HDD 314 and are required to implement the functional units shown in FIG. 5. Also, the CPU 311 uses the RAM 313 and HDD 314 as storage areas as needed.

In step S950, the registration request receiving unit 501 receives a job history from the job history sending unit 404 of the MFP 101, and returns a response including an SID corresponding to the job history storage server itself. Note that the registration request receiving unit 501 holds the SID acquired from the setting control unit 506 at the time of activation. After the response to the job history reception, the registration request receiving unit 501 passes the received job history to the image processing unit 502. Note that when the registration request receiving unit 501 receives an SID together with the job history, it passes the received SID to the image processing unit 502 together with the job history. Assume that when the job history is passed to different processing units in the subsequent steps, the received SID is similarly passed together.

In step S951, the registration request receiving unit 501 passes the received job history to the image processing unit 502. Then, the image processing unit 502 determines whether or not the passed job history is a link log. This determination processing is executed by the same method as in step S901. If the received job history is a link log (YES in step S951), the image processing unit 502 passes the job history to the registration processing unit 503 intact, and advances the process to step S953. If the received job history is not a link log, that is, it is a normal log (NO in step S951), the image processing unit 502 advances the process to step S952. In step S952, the image processing unit 502 applies processing including format conversion, resolution conversion, OCR processing, and the like to a log image in the job history as needed. Then, the image processing unit 502 passes a content (a log image which has undergone the image processing and text extracted by the OCR processing) obtained as a result and attribute information to the registration processing unit 503 as the job history.

In step S953, the registration processing unit 503 registers the job history passed from the image processing unit 502 in the database on the HDD 314. The registration processing unit 503 determines in step S954 whether or not the job history registered in step S953 is a link log. This determination processing is executed by the same method as in step S901. If the registered job history is a link log (YES in step S954), the registration processing unit 503 advances the process to step S955. If the registered job history is not a link log, that is, it is a normal log (NO in step S954), the registration processing unit 503 ends the series of processes shown in FIG. 9B.

In step S955, the registration processing unit 503 requests the copy request receiving unit 507 of the job history storage server identified by the SID passed together with the job history as a link log to copy a content corresponding to a document ID in the link log. At this time, the registration processing unit 503 acquires address information corresponding to the SID from those held by the setting control unit 506, and issues a request to the job history storage server, which holds the content, using that address information. Then, the registration processing unit 503 receives the content returned from the copy request receiving unit 507, which received the request, and stores the content by registering it in the database on the HDD 314 in association with the link log registered in step S953.

Note that when the received SID is the self SID, a copy is not required. However, in consideration of efficiency at the time of a search, a content may be copied. Also, upon reception of a link log, a content copy request is issued. However, the present invention is not limited to this. For example, document IDs designated by received link logs may be held as a list, and contents may be copied periodically. In this case, a copy request need not be issued at each reception timing of a link log.

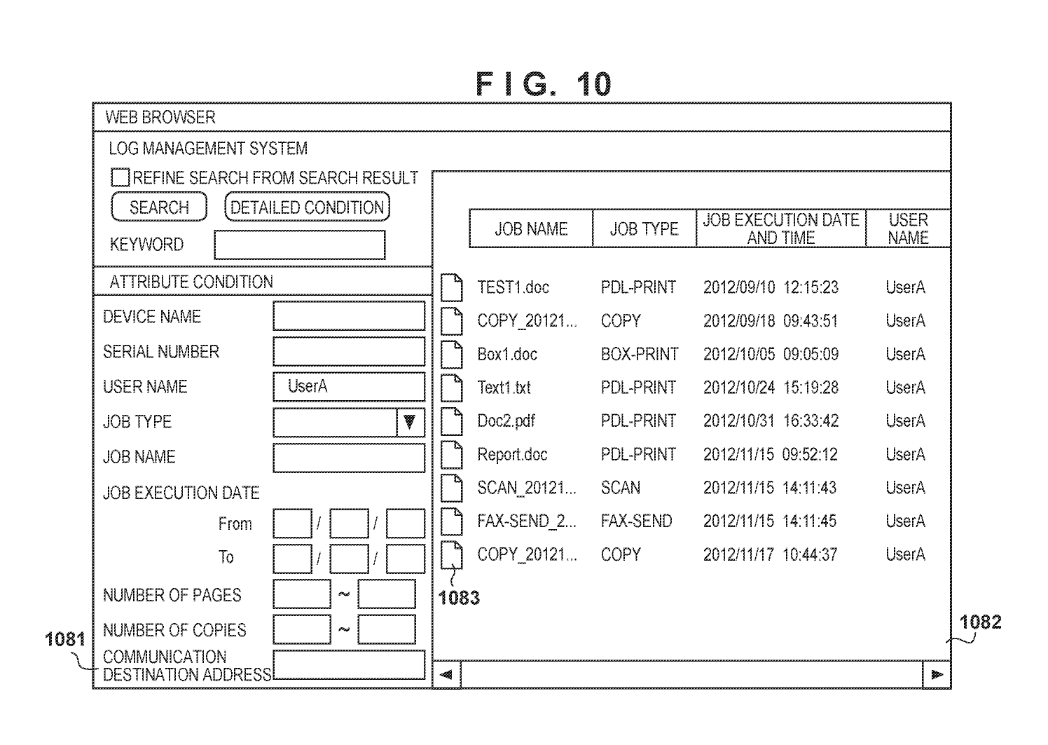

FIG. 10 shows an example of a job history search screen which is displayed by the distributed search processing unit 601 of the management server 131 for the user. Assume that in this embodiment, the search screen is displayed when the user accesses the distributed search processing unit 601 of the management server 131 using a Web browser on a PC (not shown). A search area 1081 on the left side of the screen shown in FIG. 10 is used to input search conditions. A search result area 1082 on the right side in FIG. 10 displays search results. FIG. 10 shows an example of results when a search is conducted by setting “UserA” in a “user name” attribute as the search condition. When the user presses an image icon 1083, a log image of a corresponding job history is displayed.

In the related art, when a log management system does not copy a content in association with a link log, the need for searching for a job history storage server which stores a log image arises at this timing for the first time. However, in the present invention, a content is copied in advance in association with a link log, and a log image to be displayed can be quickly acquired from the job history storage server which stores a job history of that log image.

The log management system of this embodiment includes a full-text search function for text obtained by applying OCR processing to a log image. When the log management system does not copy any content (text included in that content) in association with a link log, a full-text search for each content is temporarily conducted on the respective job history storage servers at the time of a full-text search. Then, the need for searching for normal logs or link logs associated with the corresponding content on the respective job history storage servers arises. However, in the present invention, since a content is copied in advance in association with each link log, the respective job history storage servers can independently obtain search results, thus reducing deterioration of the search performance.

As described above, according to the first embodiment, the MFP manages a registration destination SID of a content referred to by a link log, and notifies the job history storage server of the registration destination SID of the content referred to by the link log. Then, the job history storage server copies the content referred to by the link log from the job history storage server of the notified SID. Thus, in the large-scale environment, the log management system which reduces the recording capacity of job histories in the MFP (image forming apparatus) and suppresses a search performance drop when a job history is used can be provided.

Note that if the sent job history is a link log in step S904, the job history sending unit 404 may update the recorded SID by the latest link log registration destination SID. In this case, in the job history storage server of the old SID, a possibility that the content referred to by the link log cannot be copied when that content has already been deleted due to, for example, an expired storage period can be reduced.

### Second Embodiment

The second embodiment of the present invention will be described below. This embodiment is different from the first embodiment in a management method of a job history registration destination, and recovery processing at the time of a copy failure. Hence, a description of portions redundant to the first embodiment will not be repeated, and only differences will be explained. Principal differences from the first embodiment lie in only the operation of a job history sending unit 404 of an MFP 101 and that of a registration processing unit 503 of a job history storage server 121, and these differences will be described below.

[Processing Sequence]

(Job History Sending Processing)

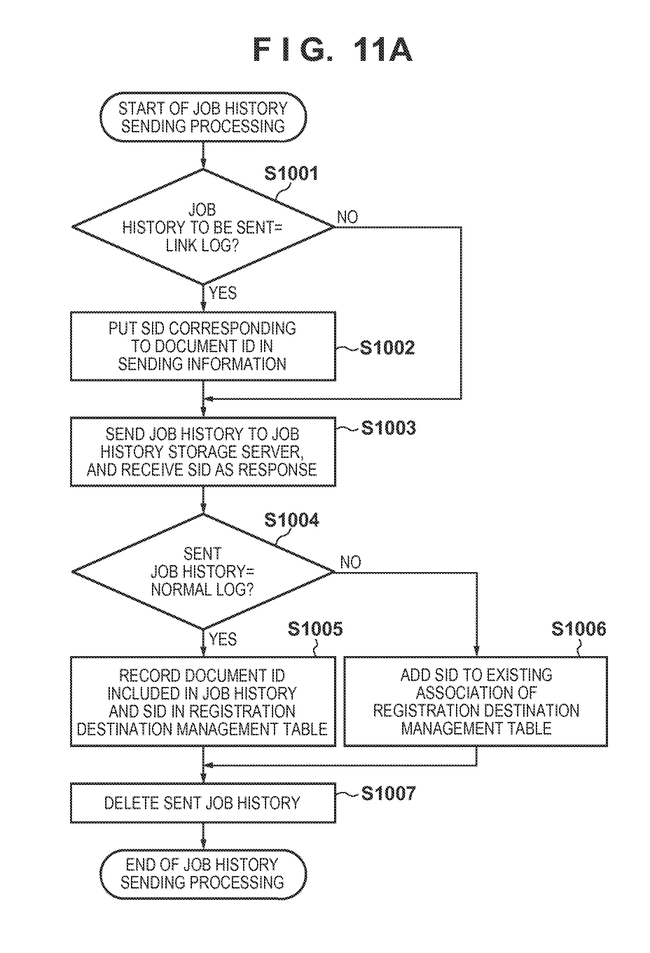

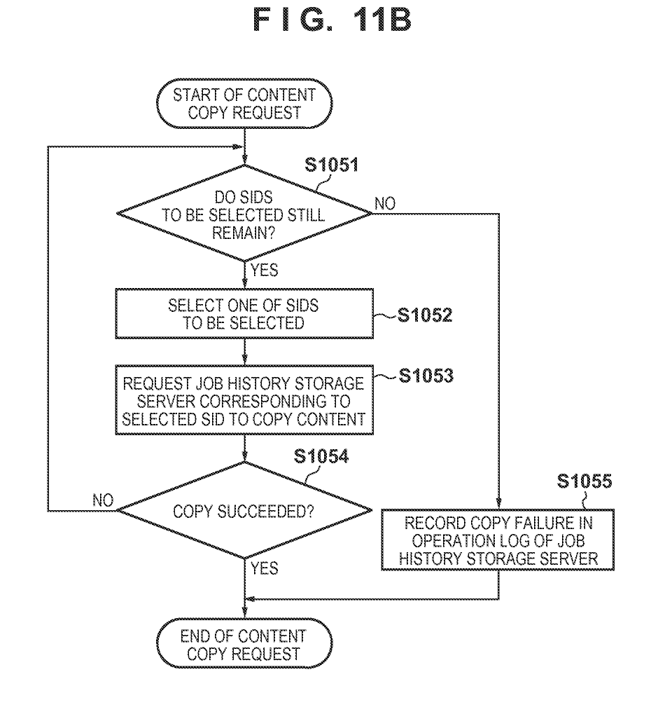

FIG. 11A is a flowchart showing the processing sequence executed when the job history sending unit 404 of the MFP 101 of this embodiment sends a job history recorded in an HDD 204. Respective steps shown in the flowchart of FIG. 11A are implemented when a CPU 201 of the MFP 101 executes a program which is stored in a ROM 203 or the HDD 204 and is required to implement the job history sending unit 404. Also, the CPU 201 uses a RAM 202 and the HDD 204 as storage areas as needed. Assume that the job history sending unit 404 refers to the HDD 204 at a pre-set time interval, and sends a job history when it finds the job history to be sent.

Since steps S1001, S1003, S1005, and S1007 in FIG. 11A are respectively the same processes as in steps S901, S903, S905, and S906 in FIG. 9A, a description thereof will not be repeated.

In step S1002, the job history sending unit 404 acquires all SIDs corresponding to a document ID of the link log from the registration destination management table, and appends these SIDs to sending information of a job history registration request to the job history storage server. The job history sending unit 404 determines in step S1004 whether or not the sent job history is a normal log. Whether or not the sent job history is a normal log is determined in the same manner as in step S904 in FIG. 9A. If the sent job history is a normal log (YES in step S1004), the job history sending unit 404 advances the process to step S1005. If the sent job history is not a normal log, that is, it is a link log (NO in step S1004), the job history sending unit 404 advances the process to step S1006. In step S1006, the job history sending unit 404 adds the SID received in step S1003 in association with the same document ID as that of the sent link log, which has already been recorded in a registration destination management table.

(Content Copy Request Processing)

The operation of the registration processing unit 503 of the job history storage server 121 will be described below. Since a difference from the first embodiment is only the processing in step S955 in FIG. 9B, this processing alone will be described below with reference to FIG. 11B.

FIG. 11B shows processes which replace step S955 in FIG. 9B, that is, it is a flowchart showing the processing sequence when the job history storage server 121 issues a copy request of a content referred to by a link log. Respective steps shown in the flowchart of FIG. 11B are implemented when a CPU 311 of the job history storage server 121 executes programs which are stored in a ROM 312 or HDD 314 and are required to implement the functional units shown in FIG. 5. Also, the CPU 311 uses a RAM 313 and the HDD 314 as storage areas as needed.

The registration processing unit 503 determines in step S1051 whether or not SIDs to be selected to issue a copy request of those received by a registration request receiving unit 501 still remain. If SIDs to be selected still remain (YES in step S1051), the registration processing unit 503 advances the process to step S1052. If no SID to be selected remains (NO in step S1051), the registration processing unit 503 advances the process to step S1055.

In step S1052, the registration processing unit 503 selects one of SIDs to be selected to issue a copy request of those received by the registration request receiving unit 501. In step S1053, the registration processing unit 503 issues a copy request of a content corresponding to a document ID of a link log to a copy request receiving unit 507 of a job history storage server identified by the SID selected in step S1052.

The registration processing unit 503 determines in step S1054 whether or not the copy request in step S1053 has succeeded. If the registration processing unit 503 normally receives the requested content from the copy request receiving unit 507 of the job history storage server as a request destination, it determines that the copy request has succeeded (YES in step S1054), thus ending the series of processes. On the other hand, If the registration processing unit 503 does not normally receive the requested content (for example, the copy request receiving unit 507 of the job history storage server as a request destination does not respond), it determines that the copy request has failed (NO in step S1054). Then, the registration processing unit 503 sets the SID selected in step S1052 to be the already selected SID, and returns the process to step S1051.

In step S1055, the registration processing unit 503 records information indicating that the content cannot be copied from any job history storage server in an operation log of the job history storage server 121, thus ending the series of processes. Note that the registration processing unit 503 may make several retries for all the SIDs before it ends the processing.

As described above, according to the second embodiment, all MFPs record registration destinations of link logs, and send the information to job history storage servers. Thus, a job history storage server which received a link log can acquire a content from another job history storage server even when a job history storage server of a content copy request destination is down, thus improving the availability.

### Third Embodiment

The third embodiment of the present invention will be described below. This embodiment is different from the first embodiment in that unnecessary information of a registration destination management table is deleted. Hence, a description of portions redundant to the first embodiment will not be repeated, and only differences will be explained. Principal differences from the first embodiment lie in the operations of a job management unit 401, operation control unit 402, and job history sending unit 404.

(Processing After Job Processing)

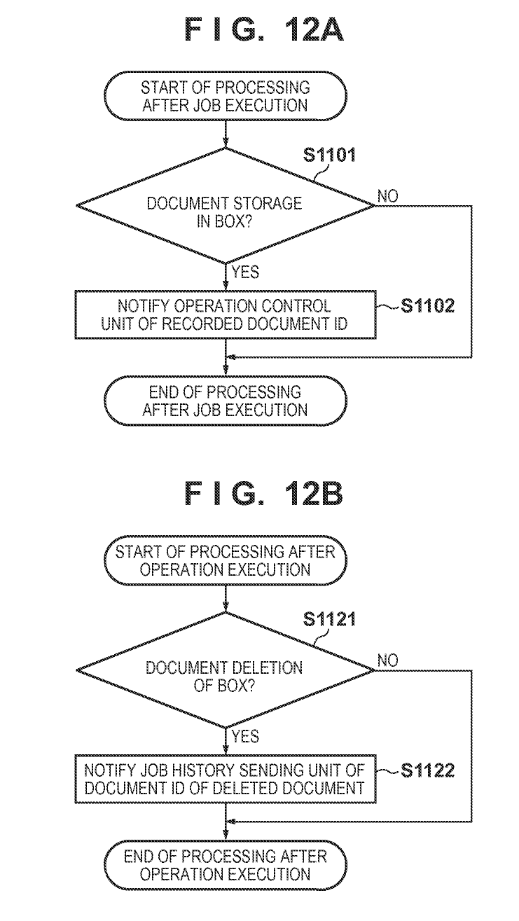

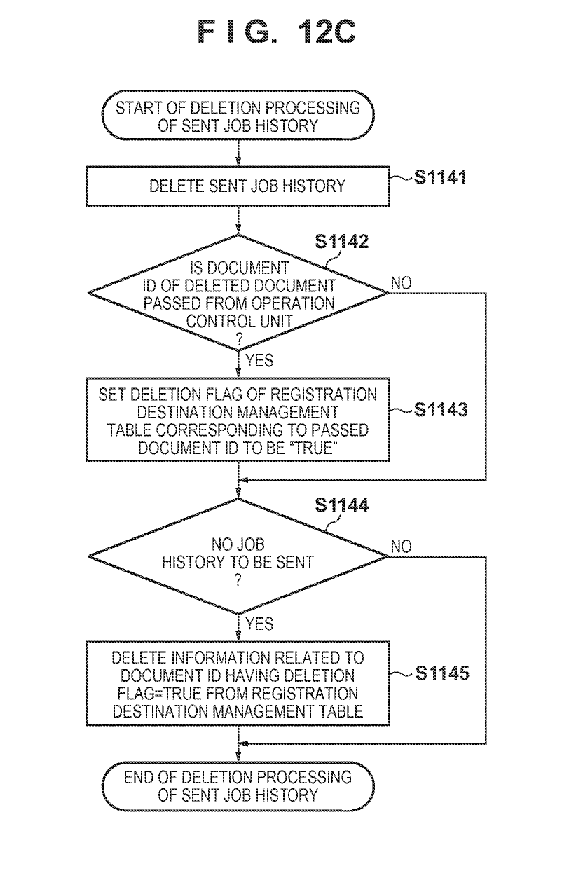

FIG. 12A is a flowchart showing the operation after the job management unit 401 executes a job and records a job history. Respective steps shown in the flowchart of FIG. 12A are implemented when a CPU 201 of an MFP 101 executes a program which is stored in a ROM 203 or HDD 204 and is required to implement the job management unit 401. Also, the CPU 201 uses a RAM 202 and the HDD 204 as storage areas as needed.

The job management unit 401 determines in step S1101 whether or not the executed job is that which performs document storage processing in a BOX. This determination is made based on a job type of a job history. For example, in case of a BOX storage job, the job management unit 401 determines that the document storage processing in the BOX is performed (YES in step S1101), and advances the process to step S1102. If the job management unit 401 determines that the document storage processing in the BOX is not performed (NO in step S1101), it ends this processing sequence. In step S1102, the job management unit 401 notifies the operation control unit 402 of a document ID recorded in a job history and controls the operation control unit 402 to store the document ID. Then, the job management unit 401 ends this processing sequence.

(Processing After Operation Execution)

FIG. 12B is a flowchart showing the processing sequence when the operation control unit 402 of this embodiment executes an accepted operation. Respective steps shown in the flowchart of FIG. 12B are implemented when the CPU 201 of the MFP 101 executes a program which is stored in the ROM 203 or HDD 204 and is required to implement the operation control unit 402. Also, the CPU 201 uses the RAM 202 and HDD 204 as storage areas as needed.

The operation control unit 402 determines in step S1121 whether or not the executed operation is deletion of a document stored in the BOX. If the executed operation is deletion of a document stored in the BOX (YES in step S1121), the operation control unit 402 advances the process to step S1122. Otherwise (NO in step S1121), the operation control unit 402 ends this processing sequence. In step S1122, the operation control unit 402 passes a document ID which corresponds to the deleted document and is notified from the job management unit 401 to the job history sending unit 404. At this time, the operation control unit 402 may delete the document ID of the deleted document from recorded information. Then, the operation control unit 402 ends this processing sequence.

(Deletion Processing of Sent Job History)

Next, the operation of the job history sending unit 404 will be described below. Since a difference from the first embodiment is only the processing of step S906 in FIG. 9A, that processing alone will be described below with reference to FIG. 12C. Assume that in this embodiment, a registration destination management table newly includes an item of a deletion flag for each record. Also, assume that an initial value of a deletion flag when a record is registered is “FALSE”.

FIG. 12C shows processes which replace step S906 in FIG. 9A, that is, it is a flowchart showing the processing sequence when the job history sending unit 404 deletes a sent job history from the HDD 204. Respective steps shown in the flowchart of FIG. 12C are implemented when the CPU 201 of the MFP 101 executes a program which is stored in the ROM 203 or HDD 204 and is required to implement the job history sending unit 404. Also, the CPU 201 uses the RAM 202 and HDD 204 as storage areas as needed.

In step S1141, the job history sending unit 404 deletes a sent job history. The job history sending unit 404 determines in step S1142 whether or not a document ID of the deleted document, which was passed from the operation control unit 402 in step S1122, is present. Note that the passed document ID is that of the deleted document notified in step S1122 in FIG. 12B. That is, if the document ID of the deleted document was passed, it can be judged that a link log including link information to corresponding image data is not generated in the subsequent processes. If the document ID of the deleted document was passed (YES in step S1142), the job history sending unit 404 advances the process to step S1143. If no document ID was passed (NO in step S1142), the job history sending unit 404 advances the process to step S1144. In step S1143, the job history sending unit 404 sets “TRUE” in a deletion flag corresponding to the passed document ID in the registration destination management table, and deletes the passed document ID.

The job history sending unit 404 determines in step S1144 whether or not no job history to be sent remains. If no job history to be sent remains (YES in step S1144), the job history sending unit 404 advances the process to step S1145. If job histories to be sent still remain (NO in step S1144), the job history sending unit 404 ends the series of processes shown in FIG. 12C. In step S1145, the job history sending unit 404 deletes information associated with the document ID, the deletion flag of which is “TRUE”, from the registration destination management table.

As described above, according to the third embodiment, by detecting that a link log which refers to a stored log image ceases to be generated, information in the registration destination management table is deleted at an appropriate timing. Thus, the registration destination management table can be prevented from bloating.

Note that this embodiment detects that a link log which refers to a predetermined log image ceases to be generated to have deletion of image data from the BOX as a trigger. However, the present invention is not limited to this method, and detection may be made using other methods.

### Fourth Embodiment

The fourth embodiment of the present invention will be described below. This embodiment is different from the first embodiment in that a link log itself is transferred to a job history storage server which stores a content to be referred to in place of copying of the content referred to by the link log. Thus, a description about portions redundant to the first embodiment will not be repeated, and only differences will be explained. Principal differences from the first embodiment lie in only the software configuration of a job history storage server 121 and its operation.

(Software Configuration)

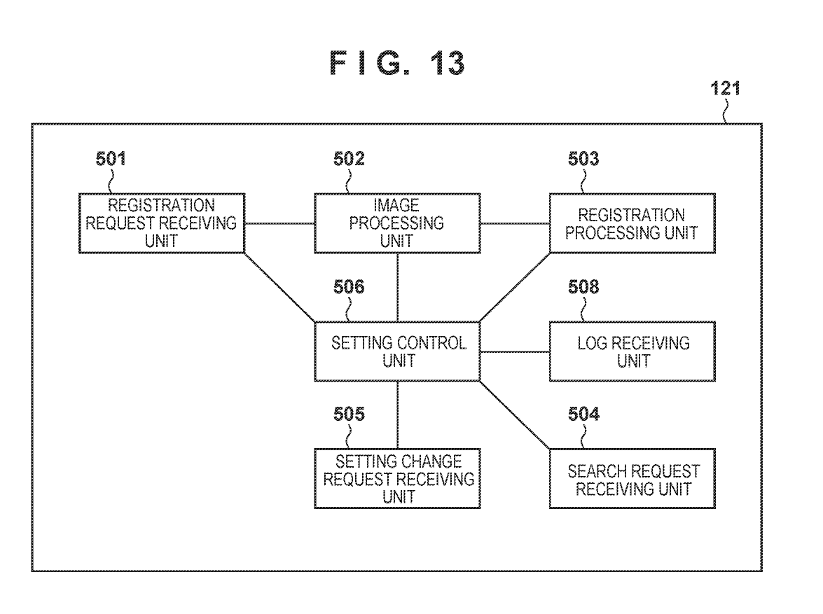

FIG. 13 is a block diagram showing an example of the software configuration of the job history storage server 121 of this embodiment. Note that job history storage servers 122 and 123 also have the same software configuration, and a description thereof will not be given. Also, since a registration request receiving unit 501, image processing unit 502 search request receiving unit 504, setting change request receiving unit 505, and setting control unit 506 in FIG. 13 are the same as those of the first embodiment, a description thereof will not be repeated.

A registration processing unit 503 registers attribute information included in a job history, and text and a log image, which are respectively extracted and converted by an image processing unit 502 in a database. However, when a job history to be registered is a link log, the registration processing unit 503 transfers that link log to a job history storage server which stores a content as a link destination. A log receiving unit 508 receives a link log transferred from the registration processing unit 503 of each job history storage server, and stores that link log in the database via the registration processing unit 503.

(Job History Receiving Processing)

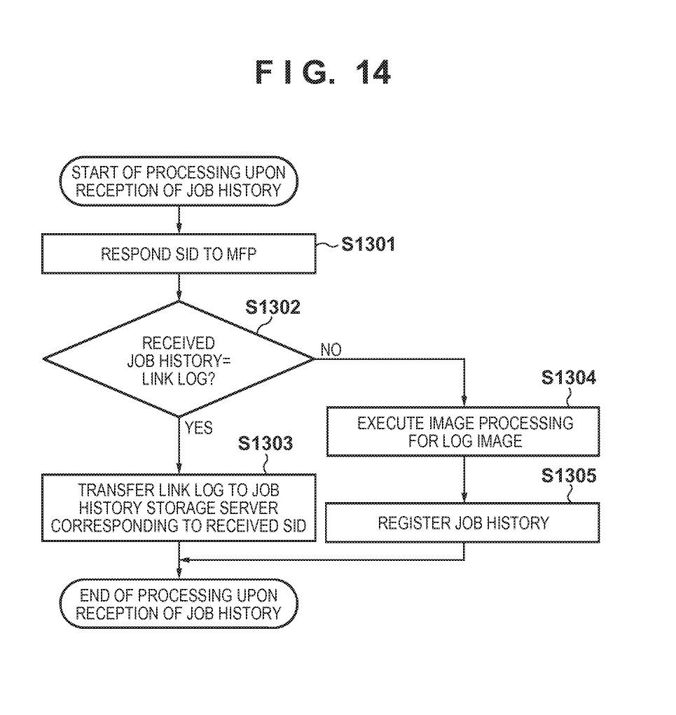

FIG. 14 is a flowchart showing the processing sequence executed when the job history storage server 121 receives a job history from a job history sending unit 404 of an MFP 101. Respective steps shown in the flowchart of FIG. 14 are implemented when a CPU 311 of the job history storage server 121 executes programs which are stored in a ROM 312 or HDD 314 and are required to implement the functional units shown in FIG. 13. Also, the CPU 311 uses a RAM 313 and the HDD 314 as storage areas as needed.

Since steps S1301, S1302, S1304, and S1305 in FIG. 14 are respectively the same processes as in steps S950, S951, S952, and S953 in FIG. 9B, a description thereof will not be repeated.

In step S1303, the registration processing unit 503 transfers a job history passed from the image processing unit 502 to the log receiving unit 508 of a job history storage server identified by an SID passed together with the job history as a link log. Note that when the received SID is the self SID, the job history need not be transferred.

As described above, according to the fourth embodiment, a link log is transferred to a job history storage server which stores a content referred to by the link log. Thus, a network load and an increase in capacity upon copying contents can be reduced.

### Fifth Embodiment

The fifth embodiment of the present invention will be described below. This embodiment is different from the first embodiment in a job history sending method of an MFP 101. Hence, a description of portions redundant to the first embodiment will not be repeated, and only differences will be explained. Principal differences from the first embodiment lie in the operation of a job history sending unit 404 of the MFP 101, and the software configuration of a job history storage server 121 and its operation.

(Software Configuration)

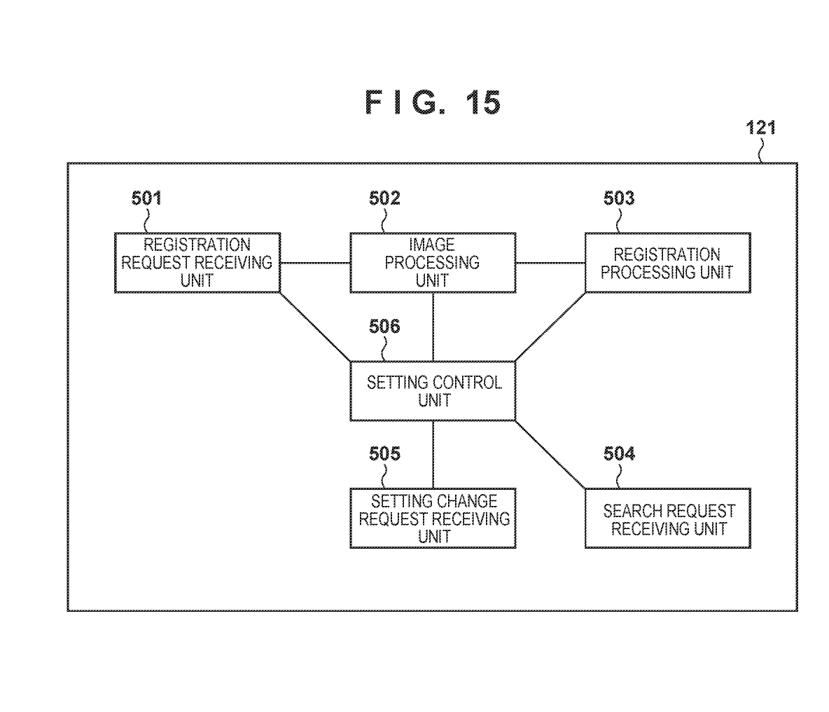

FIG. 15 is a block diagram showing an example of the software configuration of the job history storage server 121 of this embodiment. Note that job history storage servers 122 and 123 also have the same software configuration, and a description thereof will not be given. Also, differences from the first embodiment in FIG. 15 lie in that a copy request receiving unit 507 is omitted, and in the operation of a registration processing unit 503. Since a registration request receiving unit 501, image processing unit 502, search request receiving unit 504, setting change request receiving unit 505, and setting control unit 506 in FIG. 15 are the same as those of the first embodiment, a description thereof will not be repeated. The operation of the registration processing unit 503 will be described later.

(Job History Sending Processing)

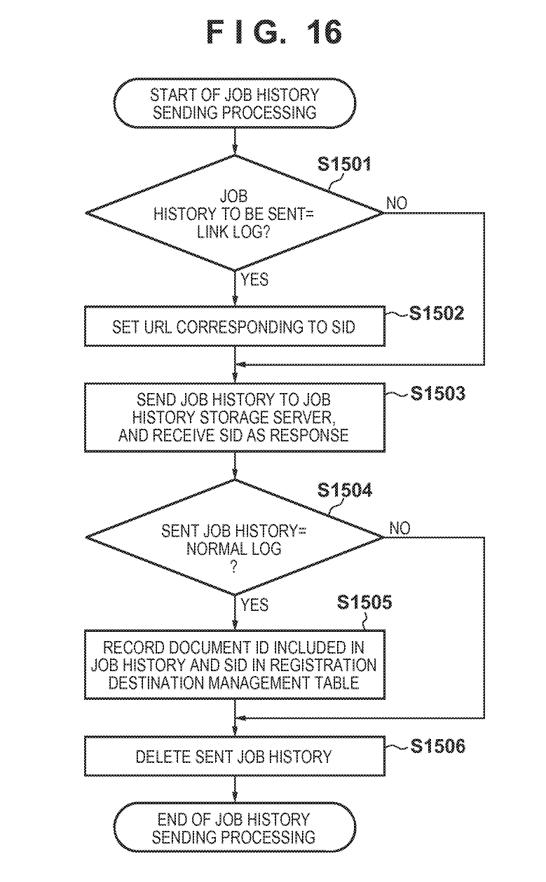

FIG. 16 is a flowchart showing the processing sequence executed when the job history sending unit 404 of the MFP 101 of this embodiment sends a job history recorded in an HDD 204. Respective steps shown in the flowchart of FIG. 16 are implemented when a CPU 201 of the MFP 101 executes a program which is stored in a ROM 203 or the HDD 204 and is required to implement the job history sending unit 404. Also, the CPU 201 uses a RAM 202 and the HDD 204 as storage areas as needed. Assume that the job history sending unit 404 refers to the HDD 204 at a pre-set time interval, and sends a job history when it finds the job history to be sent.

Since step S1501 and steps S1503 to S1506 in FIG. 16 are respectively the same processes as in step S901 and steps S903 to S906 in FIG. 9A, a description thereof will not be repeated.

In step S1502, the job history sending unit 404 acquires an SID corresponding to a document ID of a link log from a registration destination management table, and sends a job history registration request to a URL which is set in advance and corresponds to the SID. As for the URL used in this embodiment, one URL may be predefined in association with one SID, or the URL may indicate each job history storage server by appending an SID to a URL of the entire log management system as a query parameter. Assume that the URL is stored in a predetermined storage area in association with the SID.

Assume that a load balancer 111 complies with a Layer 7 (L7) server distribution function based on URLs, and settings about to which job history storage server a request is to be sent are made in advance. Note that the server distribution function provided by the load balancer 111 uses the conventional technique, and a detailed description thereof will not be given. Then, the job history registration request of the link log is sent from the job history sending unit 404 to a job history storage server which registers a content as a reference destination of the link log.

(Job History Receiving Processing)

The operation of the registration processing unit 503 of the job history storage server 121 will be described below. The processing sequence of the registration processing unit 503 of this embodiment includes steps S950 to S953 in FIG. 9B. This is because a registration request of a link log is issued to a job history storage server which registers a content as a reference destination of that link log, and the need for copy or transfer processing can be obviated unlike in the first and fourth embodiments.

As described above, according to the fifth embodiment, the function of the load balancer 111 is used to allow the job history sending unit 404 to designate a sending destination of a link log. Thus, a network load caused by content copy processing or link log transfer processing can be reduced. Note that as the function of the load balancer 111, other functions such as distribution based on Cookies, which can designate a job history storage server as a connection destination may be used.

### Sixth Embodiment

The sixth embodiment of the present invention will be described below. This embodiment is different from the first embodiment in that a management server 131 holds a registration destination management table in place of an MFP 101. Hence, a description about portions redundant to the first embodiment will not be repeated, and only differences will be explained. Principal differences from the first embodiment lie in the operation of a job history sending unit 404 of the MFP, that of a registration processing unit 503 of a job history storage server 121, and the software configuration of the management server 131 and its operation.

(Software Configuration)

FIG. 17 is a block diagram showing an example of the software configuration of the management server 131 of this embodiment. In FIG. 17, a difference from the first embodiment is that a registration destination management unit 604 is added. Since a distributed search processing unit 601, setting change acceptance unit 602, and setting control unit 603 are the same as those in the first embodiment, a description thereof will not be repeated.

The registration destination management unit 604 receives a combination of a registered document ID and an SID indicating a job history storage server in which registration is made from each job history storage server, and records it in a registration destination management table. That is, in this embodiment, the management server 131 holds the registration destination management table in place of the MFP 101 unlike in the first embodiment. The registration destination management unit 604 receives a document ID from each job history storage server, and returns an SID corresponding to the received document ID based on the registration destination management table.

(Job History Sending Processing)

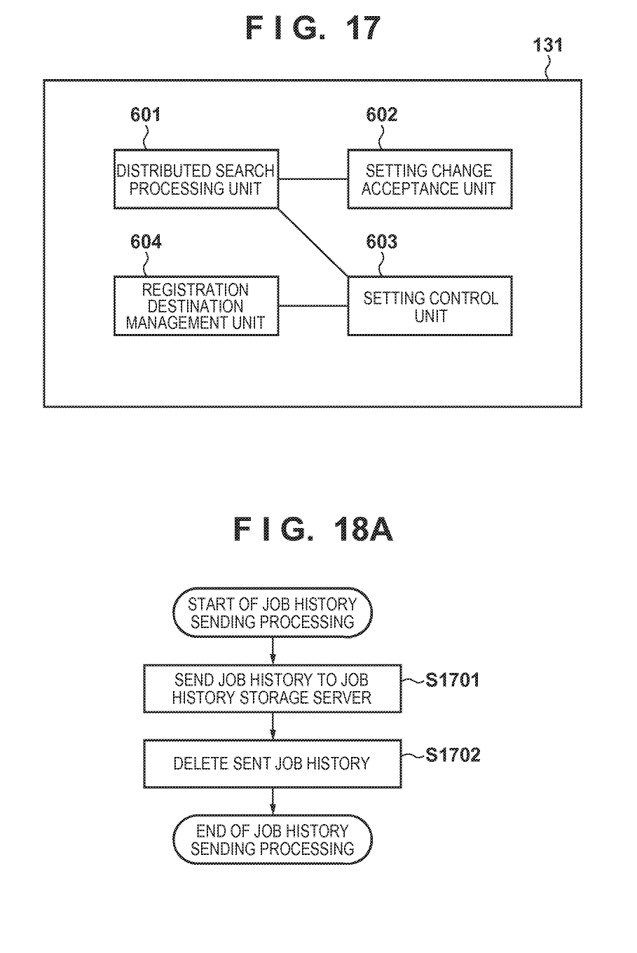

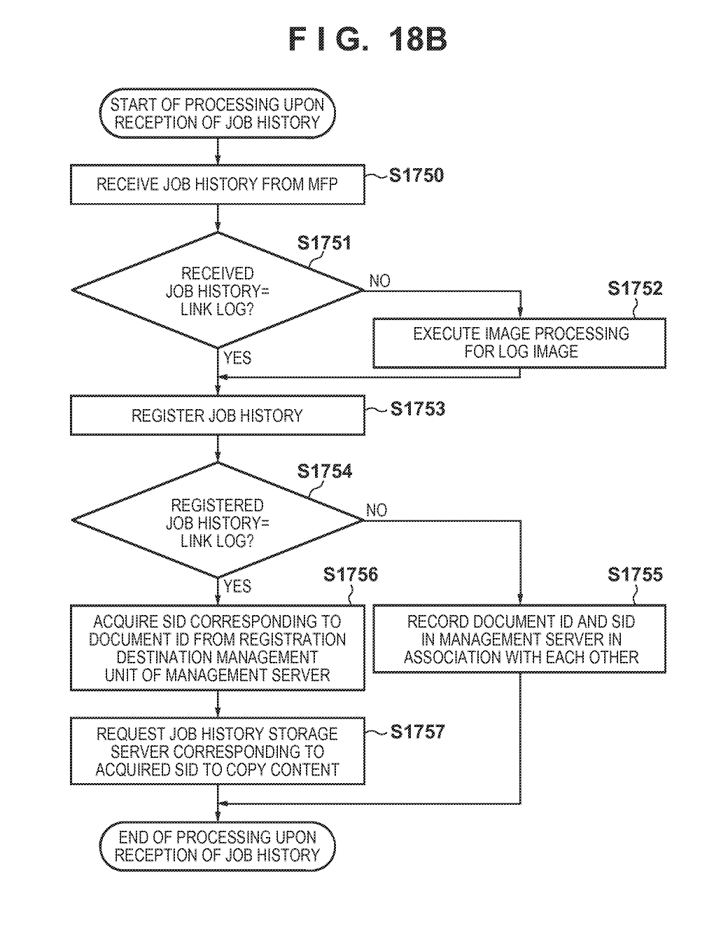

FIG. 18A is a flowchart showing the processing sequence executed when the job history sending unit 404 of the MFP 101 of this embodiment sends a job history recorded in an HDD 204. Respective steps shown in the flowchart of FIG. 18A are implemented when a CPU 201 of the MFP 101 executes a program which is stored in a ROM 203 or the HDD 204 and is required to implement the job history sending unit 404. Also, the CPU 201 uses a RAM 202 and the HDD 204 as storage areas as needed. Assume that the job history sending unit 404 refers to the HDD 204 at a pre-set time interval, and sends a job history when it finds the job history to be sent.

In step S1701, the job history sending unit 404 sends a job history registration request to the registration request receiving unit 501 of any of job history storage servers 121 to 123. The job history storage server as a registration destination is decided by load distribution processing of a load balancer 111. In step S1702, the job history sending unit 404 deletes the sent job history from the HDD 204. Thus, the job history sending unit 404 ends this processing sequence.

(Job History Receiving Processing)

FIG. 18B is a flowchart showing the processing sequence executed when the job history storage server 121 of this embodiment receives a job history from the job history sending unit 404 of the MFP 101. Respective steps shown in the flowchart of FIG. 18B are implemented when a CPU 311 of the job history storage server 121 executes programs which are stored in a ROM 312 or HDD 314 and are required to implement the functional units shown in FIG. 5. Also, the CPU 311 uses a RAM 313 and the HDD 314 as storage areas as needed.

Since steps S1751 to S1753 in FIG. 18B are respectively the same processes as in steps S951 to S953 in FIG. 9B, a description thereof will not be repeated.

In step S1750, the registration request receiving unit 501 receives a job history from the job history sending unit 404 of the MFP 101, and passes the received job history to an image processing unit 502.

The registration processing unit 503 determines in step S1754 whether or not a job history registered in step S1753 is a link log. The determination processing in this step is executed by the same method as in step S901. If the registered job history is a link log (YES in step S1754), the registration processing unit 503 advances the process to step S1756. If the registered job history is not a link log, that is, it is a normal log (NO in step S1754), the registration processing unit 503 advances the process to step S1755.

In step S1755, the registration processing unit 503 sends a combination of a document ID of the registered normal log and an SID corresponding to itself to the management server 131, thus recording them in the registration destination management table held by the registration destination management unit 604 of the management server 131. Then, the registration processing unit 503 ends this processing sequence.

In step S1756, the registration processing unit 503 sends a document ID of the link log to the registration destination management unit 604 of the management server 131 to acquire an SID corresponding to that document ID. The SID acquired at this time represents a job history storage server, which stores a content to be referred to by the link log. In step S1757, the registration processing unit 503 requests a copy request receiving unit 507 of the job history storage server identified by the SID acquired in step S1756 to copy a content corresponding to the document ID of the link log. Then, the registration processing unit 503 receives the content returned from the copy request receiving unit 507 which received the request, and registers the content in the database on the HDD 314 in association with the link log registered in step S1753. Note that when the received SID is the self SID, a content need not be copied, but it may be copied in consideration of search efficiency.

As described above, according to the sixth embodiment, the management server 131 manages registration destinations of contents referred to by link logs. Then, the job history storage server 121 sends, to the management server 131, an inquiry about a job history storage server which stores a content to be referred to by a link log, and copies the content from the job history storage server as a storage destination. Thus, even when an MFP has insufficient resources and performance required to hold the registration destination management table, the same effects as in the first embodiment can be obtained.

Note that when the management server 131 receives an inquiry from the job history storage server which stores a link log, it may directly instruct the job history storage server which stores a content to be referred to by the link log to copy the content. The job history storage server may copy a content asynchronously in place of content copy processing synchronized with link log reception.

### Seventh Embodiment

The seventh embodiment of the present invention will be described below. This embodiment is different from the sixth embodiment in that no registration destination management table is included. Thus, a description of portions redundant to the sixth embodiment will not be repeated, and only differences will be explained. Principal differences from the sixth embodiment lie in the operations of a registration processing unit 503 and search request receiving unit 504 of a job history storage server 121 and the software configuration and operation of a management server 131.

(Software Configuration)

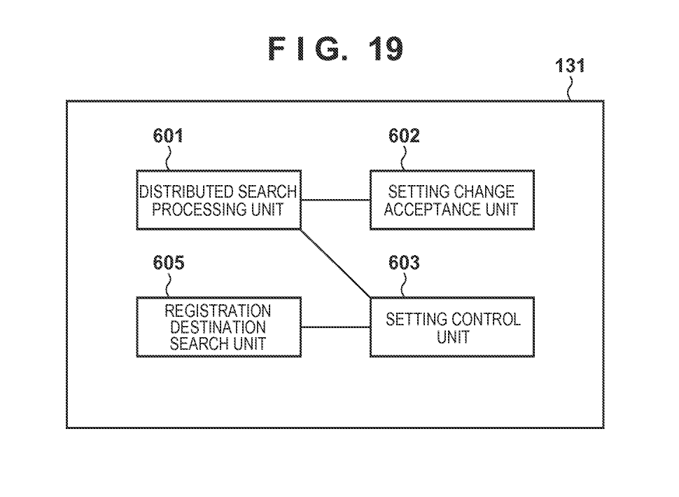

FIG. 19 is a block diagram showing an example of the software configuration of the management server 131 of this embodiment. In FIG. 19, a difference from the sixth embodiment is that a registration destination search unit 605 is arranged in place of a registration destination management unit 604. Since other functional units in FIG. 19 are the same as those in the sixth embodiment, a description thereof will not be repeated.

The registration destination search unit 605 receives a document ID from each job history storage server, searches for a job history storage server which stores a content identified by that document ID, and returns an SID of the job history storage server which stores the content. A search request may be simultaneously sent to the search request receiving units 504 of the respective job history storage servers, or may be sent in turn to these units.

(Job History Receiving Processing)

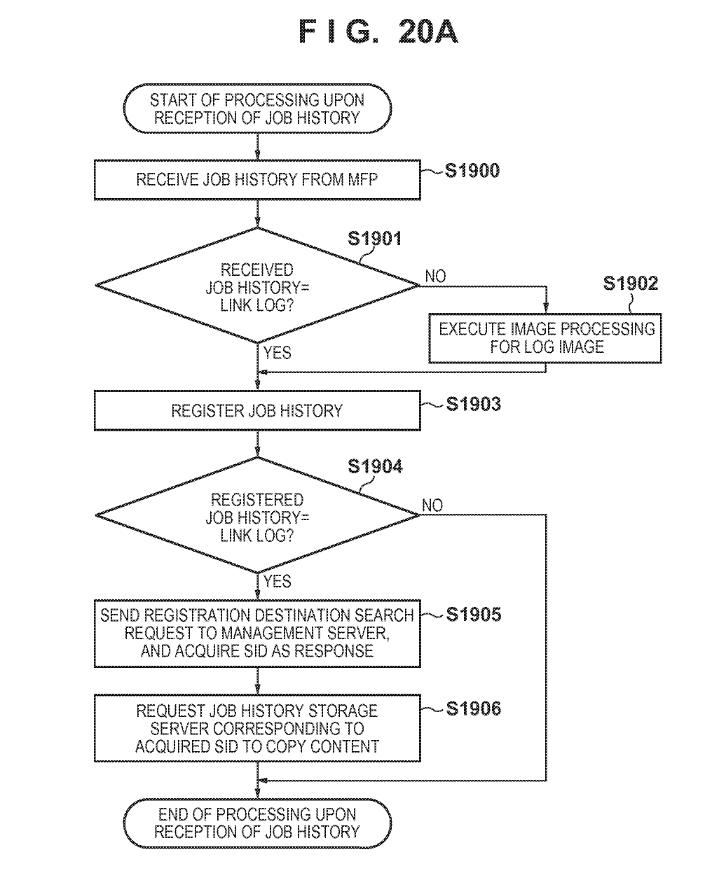

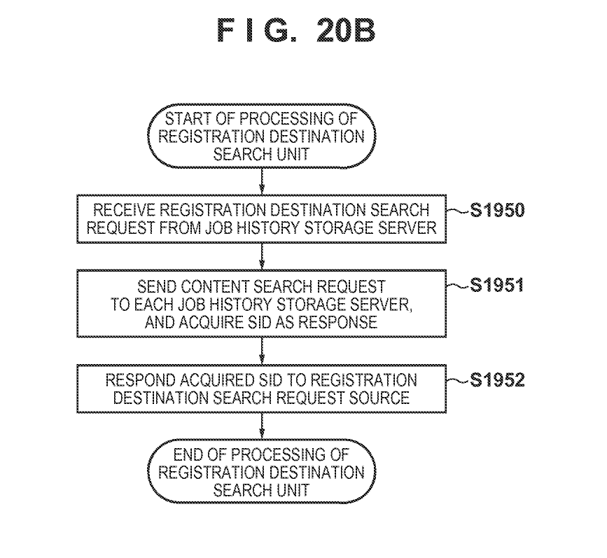

FIG. 20A is a flowchart showing the processing sequence executed when the job history storage server 121 of this embodiment receives a job history from a job history sending unit 404 of an MFP 101. Respective steps shown in the flowchart of FIG. 20A are implemented when a CPU 311 of the job history storage server 121 executes programs which are stored in a ROM 312 or HDD 314 and are required to implement the functional units shown in FIG. 5. Also, the CPU 311 uses a RAM 313 and the HDD 314 as storage areas as needed.

Since steps S1900 to S1903 in FIG. 20A are respectively the same processes as in steps S1750 to S1753 in FIG. 18B, a description thereof will not be repeated.

The registration processing unit 503 determines in step S1904 whether or not a job history registered in step S1903 is a link log. The determination processing in this step is executed by the same method as in step S901. If the registered job history is a link log (YES in step S1904), the registration processing unit 503 advances the process to step S1905. If the registered job history is not a link log, that is, it is a normal log (NO in step S1904), the registration processing unit 503 ends the series of processes shown in FIG. 20A.

In step S1905, the registration processing unit 503 sends a document ID of the link log to the registration destination search unit 605 of the management server 131 as a registration destination search request, and acquires an SID corresponding to the sent document ID as a response. The acquired SID represents a job history storage server which stores a content to be referred to by the link log. In step S1906, the registration processing unit 503 requests a copy request receiving unit 507 of the job history storage server identified by the SID acquired in step S1905 to copy a content corresponding to the document ID of the link log. Then, the registration processing unit 503 receives the content returned from the copy request receiving unit 507 which received the request, and registers the content in the database on the HDD 314 in association with the link log registered in step S1903.

Note that a plurality of SIDs may often be acquired in step S1905. In this case, when the acquired SIDs include an SID of the self server, a content need not be copied. However, a content may be copied in consideration of search efficiency. Also, normally, a copy request is sent by selecting one of the plurality of SIDs. However, when, for example, a job history storage server as a request destination is down, another SID may be selected to send a copy request.

(Registration Destination Search Processing)

FIG. 20B is a flowchart showing the operation of the registration destination search unit 605 of the management server 131 of this embodiment. Respective steps shown in the flowchart of FIG. 20B are implemented when the CPU 311 of the management server 131 executes a program which is stored in the ROM 312 or HDD 314 and is required to implement the registration destination search unit 605 shown in FIG. 19. Also, the CPU 311 uses the RAM 313 and HDD 314 as storage areas as needed.

In step S1950, the registration destination search unit 605 receives a registration destination search request sent from the registration processing unit 503 of the job history storage server 121 in step S1905 of FIG. 20A. This registration destination search request includes a document ID.

In step S1951, the registration destination search unit 605 sends a search request as to whether or not a content corresponding to the document ID acquired in step S1950 is stored to the search request receiving units 504 of respective job history storage servers. At this time, the search request receiving unit 504 of each job history storage server, which received the search request, responds a self SID when the self server stores the requested content corresponding to the document ID. Then, the registration destination search unit 605 receives responses including an SID from the job history storage server.

In step S1952, the registration destination search unit 605 returns the SID acquired in step S1951 to the registration processing unit 503 of the job history storage server as the registration destination search request source. Note that when the SID is that of the self server, a content need not be copied. However, a content may be copied in consideration of search efficiency.

As described above, according to the seventh embodiment, a registration destination of a content to be referred to by a link log is not managed, and is searched and copied when a job history is registered. Thus, the storage capacity required to manage content registration destinations and an update load of a management table can be reduced.

Note that when the management server 131 receives an inquiry from the job history storage server which stores a link log, it may directly instruct the job history storage server which stores a content to be referred to by the link log to copy the content. The job history storage server may copy a content asynchronously in place of content copy processing synchronized with link log reception. Furthermore, the function of the registration destination search unit 605 of the management server 131 may be included in respective job history storage servers, and a search request may be issued without going through the management server 131.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-057305, filed Mar. 19, 2013, which is hereby incorporated by reference herein in its entirety.

What is claimed is:

1. A log management system in which log information sent from an image forming apparatus via a load balancer, which distributes a storage destination of log information, is managed by a plurality of storage servers, said system comprising:
a management unit configured to manage identification information of a first storage server, which received first log information including image data, of the plurality of storage servers in association with identification information of the image data; and
a control unit configured to control a second storage server, which received second log information which does not include the image data and includes the identification information of the image data as reference information of the image data to copy and store the image data from the first storage server specified by using information managed by said management unit and the reference information included in the second log information.

2. A log management system in which log information sent from an image forming apparatus via a load balancer, which distributes a storage destination of the log information, is managed by a plurality of storage servers, said system comprising:
a management unit configured to manage identification information of a first storage server, which received first log information including image data, of the plurality of storage servers in association with identification information of the image data; and
a control unit configured to control a second storage server which received second log information which does not include the image data and includes the identification information of the image data as reference information of the image data to transfer the second log information to the specified storage server specified by using information by said management unit and the reference information included in the second log information.

3. A log management system in which log information sent from an image forming apparatus via a load balancer, which distributes a storage destination of the log information, is managed by a plurality of storage servers, said system comprising:
a search unit configured to search for a first storage server, which stores image data, of the plurality of storage servers; and
a control unit configured to control a second storage server which received log information which does not include the image data and includes the identification information of the image data as reference information of the image data to copy and store the image data from the first storage server found on the basis of the reference information included in the log information by said search unit.

4. The system according to claim 1, wherein each of the plurality of storage servers comprises said control unit.

5. The system according to claim 1, wherein said control unit controls to periodically copy the image data using reference information of the image data included in received log information.

6. The system according to claim 1, wherein said management unit is configured by an apparatus different from the image forming apparatus and the plurality of storage servers.

7. The system according to claim 6, wherein when each of the plurality of storage servers further comprise a unit configured to notify the apparatus comprising said management unit of identification information of itself if the storage server receives log information.

8. The system according to claim 1, wherein each of the plurality of storage servers comprises a response unit configured to respond identification information of itself to the image forming apparatus, which sent log information, if the storage server receives the log information.

9. The system according to claim 8, wherein the image forming apparatus comprises:
a sending unit configured to send log information of job processing to the log management system;
a receiving unit configured to receive identification information of the storage server serving as a storage destination of the log information as a response to the log information sent by said sending unit; and
a holding unit configured to hold identification information of image data corresponding to the log information and the identification information of the storage server received by said receiving unit in a storage unit in association with each other, and
when said sending unit sends log information, said sending unit determines based on information held in said holding unit which of the plurality of storage servers stores image data corresponding to the log information, and if the image data is stored in any of the plurality of storage servers, said sending unit sends log information which does not include the image data and includes identification information of the image data as reference information of the image data.

10. An image forming apparatus connected to a log management system including a plurality of storage servers to which a storage destination of log information is distributed by a load balancer, said apparatus comprising:
a sending unit configured to send log information of job processing to the log management system;
a receiving unit configured to receive identification information of the storage server serving as a storage destination of the log information as a response to the log information sent by said sending unit; and
a holding unit configured to hold identification information of image data corresponding to the log information and the identification information of the storage server received by said receiving unit in a storage unit in association with each other,
wherein when said sending unit sends log information, said sending unit determines based on information held in said holding unit which of the plurality of storage servers stores image data corresponding to the log information, and if the image data is stored in any of the plurality of storage servers, said sending unit sends log information which does not include the image data and includes identification information of the image data as reference information of the image data.

11. The apparatus according to claim 10, wherein of the plurality of storage servers, a storage server, which received log information which does not include image data and includes identification information of the image data as reference information of the image data, copies and stores the image data from the storage server which stores the image data.

12. The apparatus according to claim 10, wherein when said sending unit sends log information, which does not include image data and includes identification information of the image data as reference information of the image data, said sending unit sends pieces of identification information of all the storage servers which store the image data.

13. The apparatus according to claim 10, wherein log information held by said image forming apparatus is deleted when the log information is sent by said sending unit.

14. The apparatus according to claim 10, further comprising a unit configured to determine, after job processing, whether or not image data used in the job processing is deleted from the storage unit of said image forming apparatus,
wherein if the image data is deleted, said holding unit deletes information of the storage server associated with identification information of the image data.

15. The apparatus according to claim 10, further comprising a unit configured to hold address information corresponding to the storage server which stores image data,
wherein said sending unit sends log information which does not include image data and includes identification information of the image data as reference information of the image data, using address information corresponding to the storage server which stores the image data, and
the load balancer distributes the storage server serving as a storage destination based on the address information.

16. A control method in a log management system in which log information sent from an image forming apparatus via a load balancer, which distributes a storage destination of the log information, is managed by a plurality of storage servers, the method comprising:
a management step of managing identification information of a first storage server, which received first log information including image data, of the plurality of storage servers in association with identification information of the image data; and
a control step of controlling a second storage server which received second log information which does not include the image data and includes the identification information of the image data as reference information of the image data to copy and store the image data from the first storage server specified by using information managed in the management step and the reference information included in the second log information.

17. A control method of an image forming apparatus connected to a log management system including a plurality of storage servers to which a storage destination of log information is distributed by a load balancer, the method comprising:
a sending step of sending log information of job processing to the log management system;
a receiving step of receiving identification information of the storage server serving as a storage destination of the log information as a response to the log information sent in the sending step; and
a holding step of holding identification information of image data corresponding to the log information and the identification information of the storage server received in the receiving step in a storage unit in association with each other,
wherein in the sending step, when log information is sent, it is determined based on information held in the storage unit which of the plurality of storage servers stores image data corresponding to the log information, and if the image data is stored in any of the plurality of storage servers, log information, which does not include the image data and includes identification information of the image data as reference information of the image data, is sent.

18. A non-transitory computer-readable medium storing a program for controlling a computer to function as:
a sending unit configured to send log information of job processing to a log management system including a plurality of storage servers to which a storage destination of log information is distributed by a load balancer;
a receiving unit configured to receive identification information of the storage server serving as a storage destination of the log information as a response to the log information sent by the sending unit; and
a holding unit configured to hold identification information of image data corresponding to the log information and the identification information of the storage server received by the receiving unit in a storage unit in association with each other,
wherein when the sending unit sends log information, the sending unit determines based on information held in the holding unit which of the plurality of storage servers stores image data corresponding to the log information, and if the image data is stored in any of the plurality of storage servers, the sending unit sends log information which does not include the image data and includes identification information of the image data as reference information of the image data.
